(19) United States
(12) Patent Application Publication
(10) Pub. No.: US 2026/0056497 A1
(43) Pub. Date: Feb. 26, 2026

(54) IMAGE FORMING APPARATUS

(71) Applicant: Konica Minolta, Inc., Tokyo (JP)

(72) Inventor: Yuji UCHIDA, Tokyo (JP)

(21) Appl. No.: 19/288,267

(22) Filed: Aug. 1, 2025

(30) Foreign Application Priority Data
Aug. 21, 2024 (JP) 2024-139710

(51) Int. Cl. G03G 15/00

(52) U.S. Cl. CPC G03G 15/5054; G03G 15/5016; G03G 2215/00059; G03G 2215/00063; G03G 2215/0158

(57) ABSTRACT

An image forming apparatus includes a hardware processor that functions as a registration corrector and an information presenter; and a first storage. With a registration sensor, the registration corrector detects a formation manner of a registration pattern of each color formed on the intermediate transfer belt, and corrects a color shift amount of each color based on a detection result. The first storage stores measurement data of the color shift amount of each color measured by the registration corrector. The information presenter presents operation assistance information to the operator based on the measurement data stored in the first storage when the registration corrector indicates an error.

### CROSS REFERENCE TO RELATED APPLICATIONS

Japanese Patent Application No. 2024-139710 filed on Aug. 21, 2024, including description, claims, drawings, and abstract the entire disclosure is incorporated herein by reference in its entirety.

### BACKGROUND

### Technological Field

The present disclosure relates to an image forming apparatus.

### Description of Related Art

In the related art, in a color image forming apparatus utilizing an electrophotographic process technology, an intermediate transfer method using an intermediate transfer member such as an intermediate transfer belt has been mainstream. The intermediate transfer method is a method in which a toner image formed on a photosensitive drum of each color is transferred to an intermediate transfer body, and after toner images of a plurality of colors (for example, four colors of YMCK) are superimposed on the intermediate transfer body, the toner images are transferred to a sheet.

In this type of image forming apparatus, it is necessary to accurately superimpose the toner image formed on the photosensitive respective drum on the intermediate transfer belt. However, a positional shift of each color on the sheet (hereinafter, referred to as “color shift”) may occur due to a shift in positional accuracy or diameter of each photosensitive drum, a shift in positional accuracy of an optical system, aging degradation of members, or the like.

FIG. 1 is a diagram illustrating an example of a color shift type.

Examples of the color shift type are the following six types. (a) Color shift due to shift of the writing start position in the main scanning direction (direction orthogonal to the running direction of the intermediate transfer belt) (see FIG. 1A, hereinafter referred to as “main scanning direction color shift”). (b) Color shift due to a shift in the writing start position in the sub-scanning direction (the running direction of the intermediate transfer belt) (see FIG. 1B, hereinafter referred to as “sub-scanning direction color shift”). (c) Color shift due to overall magnification errors in the main scanning direction (see FIG. 1C, hereinafter referred to as “overall magnification color shift amount”). (d) Color shift due to partial magnification errors in the main scanning direction (see FIG. 1D, hereinafter referred to as “partial magnification color shift”). (e) Color shift due to inclination of an image in the sub-scanning direction (see FIG. 1E, hereinafter referred to as “image inclination color shift (skew)”). (f) Color shift due to image curvature in the sub-scanning direction (refer to of FIG. 1F, hereinafter referred to as “image curvature color shift (bow)”).

In FIGS. 1A to 1F, the solid line represents an ideal image formation position, and a dotted line represents an actual image formation position. Further, d1, d2, d3, d4, d5, and d6 represent the amount of positional shift between the ideal image formation position and the actual image formation position, that is, the color shift amount.

In order to prevent such color shift, a registration pattern for color shift correction is formed on the outer peripheral surface of the intermediate transfer belt when printing on a sheet is not performed, and registration correction for color shift is performed based on a detection result of the registration pattern. See, e.g., Japanese Unexamined Patent Publication No. 2010-217300.

### SUMMARY

Incidentally, in this type of image forming apparatus, there are various factors causing the color shift, such as the assembly of the photosensitive drum, the assembly of the exposure device, the belt speed fluctuation of the intermediate transfer belt, and the like, for example. Then, the color shift type varies depending on the states of these components. In other words, related components are different for each of the above-described six types (main scanning, overall horizontal magnification, partial horizontal magnification, sub-scanning, skew, and bow) of the color shift types.

Usually, in performing registration correction in this type of image forming apparatus, image formation conditions of the respective components as described above are corrected for each color shift type, but there is a limit to the correctable range thereof. Therefore, in a case where a color shift that exceeds its correctable range is detected in this type of image forming apparatus, the error is output, and the operation of the apparatus is stopped. In addition, in this type of image forming apparatus, even in a case where the color shift amount differs for each measurement in a plurality of times of color shift measurement, it is determined that there is some abnormality in the apparatus, and the error is output, and, the operation of the apparatus is stopped.

In such a case, for example, an operator performs an adjustment operation of mechanically adjusting each portion (e.g., the photosensitive drum, the exposure device, and the intermediate transfer belt) in the image forming apparatus.

In a case where such a registration correction function becomes an error in a current image forming apparatus, the operator cannot recognize a target on which adjustment operation is to be performed. Therefore, at the time of performing such adjustment operation, the operator is currently forced to comprehensively check each part in the image forming apparatus and adjust the components. Therefore, there may be a case where the necessary adjustment is not completely performed and an error frequently occurs.

Under such a background, there is a demand for reducing a workload of adjustment operation for an image forming apparatus when an error occurs in the registration correction function.

An object of the present invention is to provide an image forming apparatus that can reduce the workload of adjustment operation by an operator when an error occurs in a registration correction function.

In order to achieve at least one of the above-described objects, an image forming apparatus reflecting one aspect of the present invention forms a color image by superimposing on an intermediate transfer belt images formed on a photosensitive drum of each color, the image forming apparatus including: the photosensitive drum of each color; a hardware processor that functions as a registration corrector and an information presenter; and a first storage. With a registration sensor, the registration corrector detects a formation manner of a registration pattern of each color formed on the intermediate transfer belt, and corrects a color shift amount of each color based on a detection result. The first storage stores measurement data of the color shift amount of each color measured by the registration corrector. The information presenter presents operation assistance information to the operator based on the measurement data stored in the first storage when the registration corrector indicates an error.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A to 1F are diagrams illustrating examples of color shift types;

FIG. 2 is a diagram illustrating a schematic configuration of an image forming apparatus and includes;

FIG. 3 is a block diagram illustrating a configuration of a control system of the image forming apparatus;

FIG. 4 is a diagram illustrating a functional configuration of a controller of the image forming apparatus;

FIGS. 5A and 5B are diagrams illustrating examples of arrangement positions of a registration sensor and formation positions of a registration pattern;

FIG. 6 is a diagram illustrating an example of a method of measuring the color shift amount;

FIG. 7 is a diagram illustrating an example of measurement data of a color shift amount stored in a storage;

FIG. 8 is a diagram illustrating a display example 1 of the list of error statuses;

FIG. 9 is a diagram illustrating a display example 2 of a list of error statuses;

FIG. 10 is a diagram illustrating a display example 3 of a list of error statuses;

FIG. 11 is a diagram illustrating an example of a situation in which a color shift amount is not stable;

FIG. 12 is a diagram illustrating an example of a situation in which the color shift amount exceeds the correctable range;

FIG. 13 is a diagram illustrating an example of a situation in which a belt speed shift of the intermediate transfer belt occurs;

FIG. 14 is a diagram illustrating a mechanism of occurrence of a belt speed shift of the intermediate transfer belt;

FIG. 15 is a diagram illustrating a display example of an alert display for a belt speed shift of the intermediate transfer belt;

FIG. 16 is a diagram illustrating an example of related component data stored in a storage;

FIG. 17 is a diagram illustrating a display example of an error-related component display;

FIG. 18 is a diagram illustrating an example of an adjustment-required location expected from an error status during registration correction, and includes;

FIG. 19 is a diagram illustrating a modification example of a display example of an error-related component display;

FIG. 20 is a diagram illustrating an example of a flowchart for determining whether a related component of the color K is a cause of error occurrence;

FIG. 21 is a diagram illustrating an example of operation history data stored in a storage; and

FIG. 22 is a diagram illustrating a display example of an operation history display.

### DETAILED DESCRIPTION OF EMBODIMENTS

Hereinafter, one or more embodiments of the present invention will be described with reference to the drawings. However, the scope of the invention is not limited to the disclosed embodiments.

### Overall Configuration of Image Forming Apparatus 1

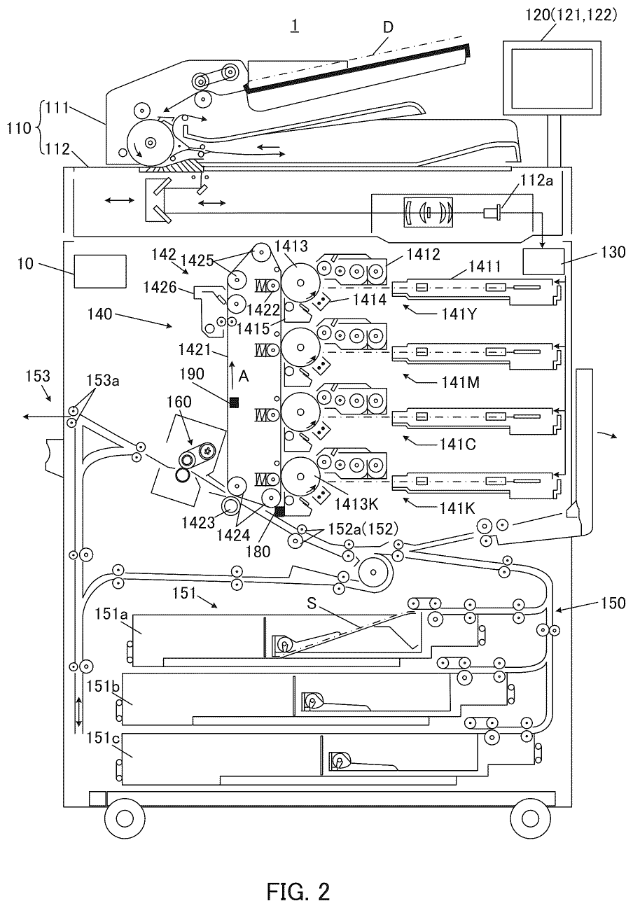

Hereinafter, an example of the overall configuration of an image forming apparatus (hereinafter, referred to as an “image forming apparatus 1”) according to an embodiment of the present invention will be described with reference to FIGS. 2 to 4.

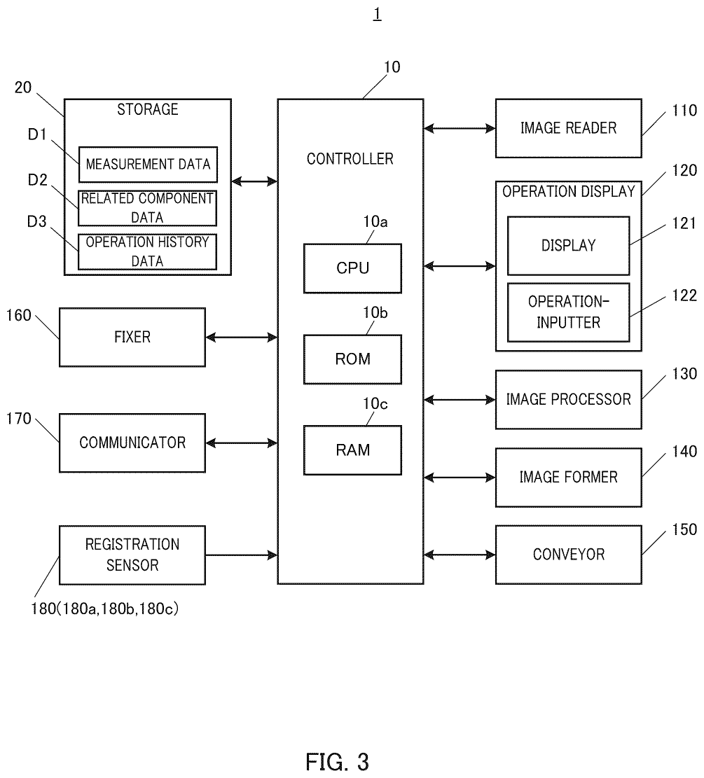

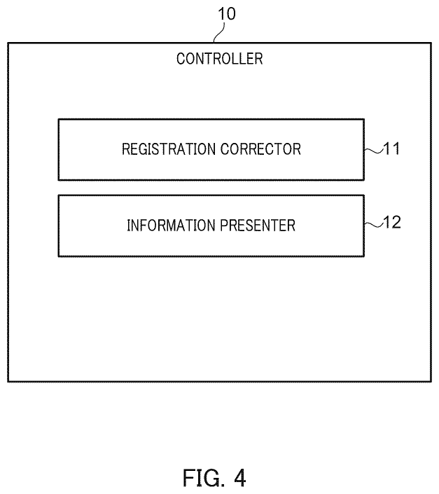

FIG. 2 is a diagram illustrating a schematic configuration of the image forming apparatus 1. FIG. 3 is a block diagram illustrating a configuration of a control system of the image forming apparatus 1. FIG. 4 is a diagram illustrating a functional configuration of a controller 10 of the image forming apparatus 1.

The image forming apparatus 1 is, for example, an intermediate transfer type color image forming apparatus utilizing an electrophotographic process technology. The image forming apparatus 1 forms an image by primarily transferring toner images of respective colors formed on photosensitive drums of the respective colors onto an intermediate transfer belt, superimposing the toner images of the respective colors on the intermediate transfer belt, and then secondarily transferring the superimposed toner images onto a sheet. Here, the image forming apparatus 1 uses four colors of C (cyan), M (magenta), Y (yellow), and K (black).

The image forming apparatus 1 includes the controller 10, a storage 20, an image reader 110, an operation display 120, an image processor 130, an image former 140, a conveyor 150, a fixer 160, a communicator 170, a registration sensor 180, and the like.

The controller 10 comprehensively controls each part of image forming apparatus 1. The controller 10 includes a CPU 10a, a ROM 10b, a RAM 10c, and the like. The CPU 10a reads a program corresponding to the processing content from the ROM 10b, develops the program in the RAM 10c, and centrally controls the operation of each block of the image forming apparatus 1 in cooperation with the developed program. At this time, various data stored in the storage 20 (e.g., print data of the registration patterns 200 of the respective colors) are referred to.

The controller 10 functions as a registration corrector 11 and an information presenter 12. The registration corrector 11 has the function of detecting, with the registration sensor 180, the formation manner of the registration patterns 200 of the respective colors formed on an intermediate transfer belt 1421 and correcting the color shift amounts of the respective colors based on the detection result. Further, when the registration corrector 11 indicates an error, the information presenter 12 presents operation assistance information to the operator based on measurement data D1 stored in the storage 20.

The storage 20 stores various data to be referred to by the controller 10 when the functions of the registration corrector 11 and the information presenter 12 are implemented. To be specific, the storage 20 stores the measurement data D1 of the color shift amount of each color measured during registration correction. Further, the storage 20 stores related component data D2 which is a component relating to the registration correction of various components in the image forming apparatus 1. In addition, the storage 20 stores an operation history data D3 which is operation history data of operation performed on the image forming apparatus 1 by an operator.

The communicator 170 transmits/receives various types of data to/from an external device (e.g., a personal computer) connected to a network such as a LAN or a WAN. The controller 10 is capable of receiving image data transmitted from an external device via the communicator 170.

The image reader 110 includes an automatic document feeder (ADF) 111 and an image scanning device 112.

The automatic document feeder 111 conveys a document D placed on a document tray by a conveyance mechanism and sends the document to the image scanning device 112. When a large number of documents D are placed on the document tray, the automatic document feeder 111 can continuously read the images of the documents D.

The image scanning device 112 optically scans a document conveyed from the automatic document feeder 111 onto a contact glass or a document placed on the contact glass, forms an image of reflected light from the document on a light receiving surface of the CCD sensor 112a, and reads the document image. The image reader 110 generates input image data based on a result of reading by the image scanning device 112. The image processor 130 performs predetermined image processing on the input image data.

The operation display 120 is constituted by, for example, a liquid crystal display with a touch screen, and functions as a display 121 and an operation-inputter 122. According to a display control signal input from the controller 10, the display 121 displays various operation screens, states of images, operating statuses of each function, or the like. The operation-inputter 122 includes various operation keys such as a numeric keypad and a start key, receives various input operation from a user, and outputs an operation signal to the controller 10.

The image processor 130 includes a circuit and the like that applies digital image processing to input image data in accordance with initial settings or user settings. The image former 140 is controlled on the basis of the image data subjected to the digital image processing.

The image former 140 includes toner image formers 141Y, 141M, 141C, and 141K for forming images with toner of Y, M, C, and K components, respectively, and an intermediate transfer member 142.

The image former 140 has a configuration in which photosensitive drums 1413 corresponding to four colors of the toner image formers 141Y, 141M, 141C, and 141K are arranged in series in the running direction of the intermediate transfer belt 1421. Then, the image former 140 sequentially transfers the toner images of the respective colors onto the intermediate transfer belt 1421 (also referred to as a tandem-system).

The toner image formers 141Y, 141M, 141C, and 141K for the Y, M, C, and K components have the same configuration. For convenience of illustration and description, common constituent elements are denoted by the same reference numerals, and when the components are distinguished from each other, Y, M, C, or K is added to the reference numerals. In FIG. 2, reference signs are representatively provided to the constituent elements of the toner image former 141Y for the Y constituent elements and the reference signs of the constituent elements of the other toner image formers 141M, 141C, 141K are omitted.

The configuration of the toner image former 141 will be described by taking the toner image former 141Y as an example. The toner image former 141Y includes an exposure device 1411, a developing device 1412, a photosensitive drum 1413, a charging device 1414, a drum cleaning device 1415, and the like.

The photosensitive drum 1413 is an organic photoreceptor formed, for example, with an under coated layer, a charge generation layer, and a charge transport layer, sequentially stacked on a peripheral surface of an aluminum conductive cylindrical body.

The charging device 1414 uniformly and negatively charges the surface of the photosensitive drum 1413 having photoconductivity. The exposure device 1411 is, for example, a semiconductor laser and emits laser light corresponding to the image in each color component onto the photosensitive drum 1413, so that an electrostatic latent image in each color component is formed on the surface of the photosensitive drum 1413.

The developing device 1412 contains a developer of each color component, and develops the electrostatic latent image on the surface of the photosensitive drum 1413 to attach a toner of each color component, thereby visualizing the electrostatic latent image to form a toner image.

The drum cleaning device 1415 includes a cleaning blade that comes in sliding contact with the surface of the photosensitive drum 1413. The transfer residual toner remaining on the surface of the photosensitive drum 1413 after primary transfer is scraped off and removed by the cleaning blade.

The intermediate transfer body 142 includes the intermediate transfer belt 1421, a primary transfer roller 1422, a secondary transfer roller 1423, a drive roller 1424, a driven roller 1425, and a belt cleaning device 1426.

The intermediate transfer belt 1421 is formed of an endless belt, and is stretched around the drive roller 1424 and the driven roller 1425. The intermediate transfer belt 1421 travels at a constant speed in a direction of an arrow A by rotation of the drive roller 1424. When the intermediate transfer belt 1421 is brought into pressure contact with the photosensitive drum 1413 by the primary transfer roller 1422, the toner images of the respective colors are sequentially primary-transferred onto the intermediate transfer belt 1421 in a superimposed manner. Next, when the intermediate transfer belt 1421 is pressed against the sheet S by the secondary transfer roller 1423, the toner image primarily transferred to the intermediate transfer belt 1421 is secondarily transferred to the sheet S.

The belt cleaning device 1426 includes a cleaning blade that comes in sliding contact with the surface of the intermediate transfer belt 1421. The transfer residual toner remaining on the surface of the intermediate transfer belt 1421 after the secondary transfer is scraped off and removed by the cleaning blade.

The fixer 160 applies heating and pressurizing to the conveyed sheet S at the fixing nip, thereby fixing the toner image on the sheet S. The fixer 160 causes the sheet S to pass through a fixing nip part formed by pressing a pair of fixing members against each other, and applies heat from a heat source to the toner image transferred onto the sheet S, thereby fixing the toner image onto the sheet S.

The conveyor 150 includes a sheet feeder 151, a conveyance mechanism 152, and a sheet ejector 153. In three sheet feed trays 151a to 151c constituting the sheet feeder 151, the sheets S identified based on the basis weight, size, and the like of the sheets are accommodated for each type set in advance.

The sheets S contained in the sheet feed trays 151a to 151c are fed one by one from the top and conveyed to the image former 140 by the conveyance mechanism 152 including a plurality of conveyance rollers such as a registration roller 152a. Next, in the image former 140, the toner image on the intermediate transfer belt 1421 is collectively transferred, by secondary transfer, onto one surface of the sheet S, and then, undergoes a fixing process in the fixer 160. The sheet S carrying an image formation is discharged to the outside of the image forming apparatus 1 by the sheet ejector 153 having a sheet ejection roller 153a.

The registration sensor 180 is, for example, a reflective optical sensor which incorporates a light emitting element such as a light emitting diode and a light receiving element such as a photodiode. The registration sensor 180 is arranged at a position on the downstream side of the photosensitive drum 1413K and on the upstream side of the secondary transfer roller 1423 in the running direction of the intermediate transfer belt 1421 so as to face the outer periphery surface of the intermediate transfer belt 1421.

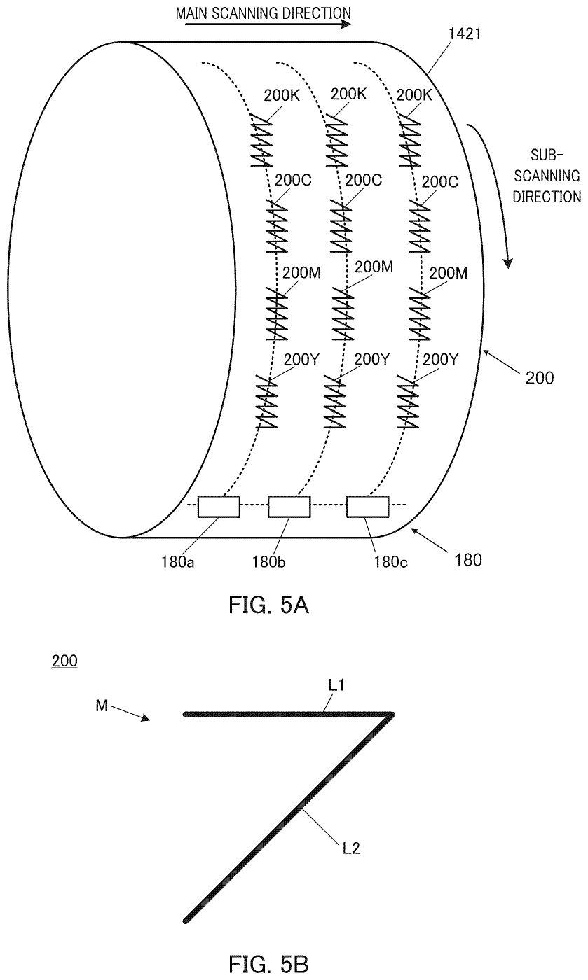

FIG. 5A is a diagram illustrating an example of the arrangement position of the registration sensor 180 and the formation position of the registration pattern 200. FIG. 5B is a diagram illustrating an exemplary configuration of a registration pattern 200.

The registration sensor 180 includes three registration sensors 180a, 180b, and 180c. Three registration sensor 180a, 180b, and 180c are arranged at both end portions and a central portion of the intermediate transfer belt 1421 in the main scanning direction at predetermined intervals.

The registration sensor 180 detects a registration pattern 200 for color shift correction formed on the outer periphery surface of the intermediate transfer belt 1421 during registration correction. The timing at which the registration correction is executed includes, for example, the time when the power of the image forming apparatus 1 is turned on, the time when the number of printed sheets reaches a predetermined number, the time when the execution of the registration correction is selected by a user via the operation-inputter 122, and the like.

The registration pattern 200 includes a registration pattern 200Y, a registration pattern 200M, a registration pattern 200C, and a registration pattern 200K. Here, the registration pattern 200Y is a registration pattern formed by the toner image former 141Y. The registration pattern 200M is a registration pattern formed by the toner image former 141M. The registration pattern 200C is a registration pattern formed by the toner image former 141C. Further, the registration pattern 200K is a registration pattern formed by the toner image former 141K. When they are not particularly distinguished from each other, they are collectively referred to as “registration pattern 200”.

The registration pattern 200 is formed by, for example, continuously forming five marks M illustrated in FIG. 5B in the sub-scanning direction of the intermediate transfer belt 1421. Here, the mark M includes, for example, a line segment L1 parallel to the main scanning direction of the intermediate transfer belt 1421 and a line segment L2 having a predetermined angle (for example, 45°) with respect to the main scanning direction. Hereinafter, among the marks M, the line segment L1 is referred to as a “main scanning direction image”, and the line segment L2 is referred to as an “oblique direction image”.

Here, the reason why five marks M are formed for each color registration pattern 200 is to detect the image formation position of each color registration pattern 200 and to correct it accurately. That is, the calculation of the color shift amounts for five times is performed with the five marks M of the respective color registration patterns 200. Specifically, the first color shift amount is calculated with reference to the uppermost mark M of each color registration pattern 200. The second color shift amount is calculated with reference to the second mark M of each of the color registration patterns 200, 201, 202, and 203. The third color shift amount is calculated with reference to the third mark M of each color registration pattern 200. The fourth color shift amount is calculated with reference to the fourth mark M of each color registration pattern 200. The fifth color shift amount is calculated with reference to the fifth mark M of each color registration pattern 200.

The reason why three registration patterns 200 are formed in the main scanning direction of the intermediate transfer belt 1421 is to measure the color shift amount in each color shift type. That is, this is because the registration correction is executed for all of the main scanning direction color shift, the sub-scanning direction color shift, the overall magnification color shift amount, the partial magnification color shift, the skew, and the bow color shift.

### Registration Corrector 11

Next, a function of the controller 10 as the registration corrector 11 will be described.

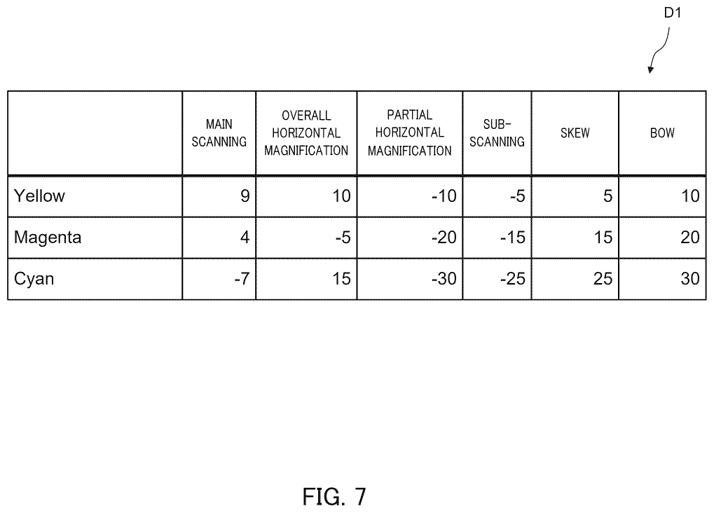

During execution of registration correction for correcting image formation conditions of the toner image formers 141Y, 141M, 141C, and 141K, the controller 10 (registration corrector 11) controls the toner image formers 141Y, 141M, 141C, and 141K to form the respective registration patterns 200 on the outer peripheral surface of the intermediate transfer belt 1421. Then, the controller 10 calculates the color shift amounts of the C color, the M color, and the Y color with respect to the K color based on the detection result of the registration pattern 200 by the registration sensor 180. The controller 10 records the calculated color shift amount in the storage 20 (see FIG. 7).

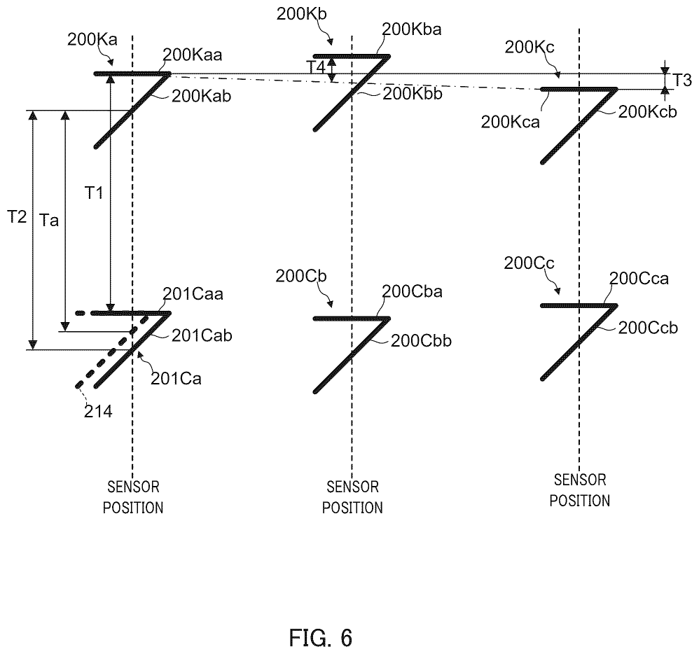

FIG. 6 is a diagram illustrating an example of a method of measuring a color shift amount.

In FIG. 6, 200Ka represents a registration pattern positioned on the left side among the three K-color registration patterns 200K formed on the intermediate transfer belt 1421 along the main scanning direction. 200Kb represents a registration pattern positioned in the middle among the three K-color registration patterns 200K formed on the intermediate transfer belt 1421 along the main scanning direction. 200Kc represents a registration pattern positioned on the right side among the three K-color registration patterns 200K formed on the intermediate transfer belt 1421 along the main scanning direction.

Similarly, in FIG. 6, 200Ca represents a registration pattern positioned on the left side among the three C-color registration patterns 200C formed on the intermediate transfer belt 1421 along the main scanning direction. “200Cb” represents a registration pattern positioned in the middle of the three C-color registration patterns 200C formed on the intermediate transfer belt 1421 along the main scanning direction. The registration pattern 200Cc represents a registration pattern positioned on the right side among the three C-color registration patterns 200C formed on the intermediate transfer belt 1421 along the main scanning direction.

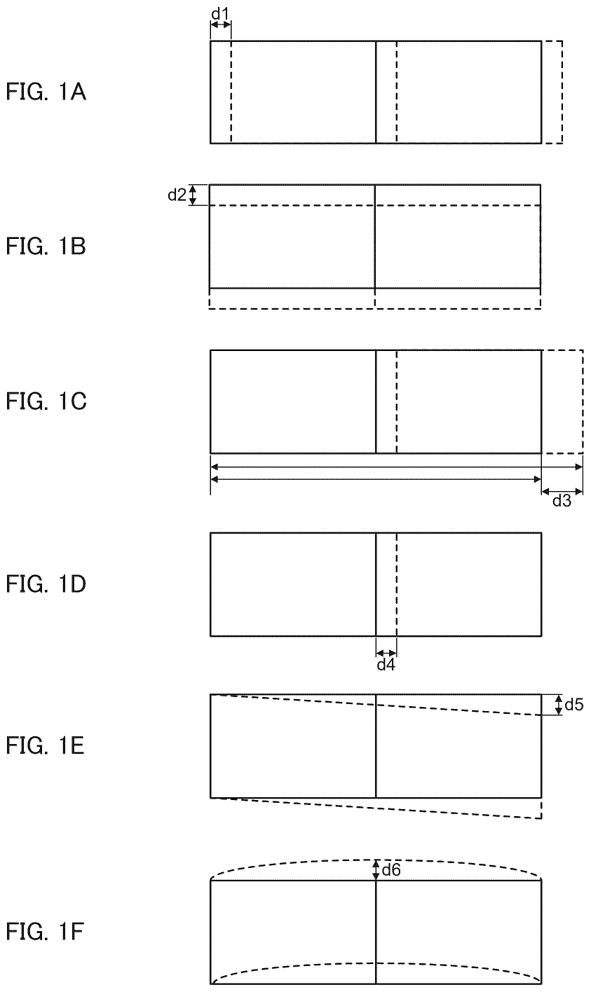

For example, the controller 10 specifies a time T1 from when the main scanning direction image 200Ka of the registration pattern 200Kaa is detected by the registration sensor 180a to when the main scanning direction image 200Ca of the registration pattern 200Caa is detected by the registration sensor 180a. Then, based on the time T1 and the traveling speed of the intermediate transfer belt 1421, the controller 10 calculates the distance between the main scanning direction images 200aa and the main scanning direction images 200Caa (hereinafter, referred to as “actual measurement distance”). The sub-scanning direction color shift amount between the K-color image and the C-color image can be calculated by calculating the difference between the actual measurement distance and the distance (design values) between the main scanning direction image 200Kaa and the main scanning direction image 200Caa (see FIG. 1b).

Further, the controller 10 specifies the time T2 from the detection of the oblique direction image 200Ka of the K-color registration pattern 200Kab by the registration sensor 180a to the detection of the oblique direction image 200Ca of the C-color registration pattern 200Cab by the registration sensor 180a. Next, the controller 10 grasps the positional relationship between the K-color image and the C-color image in the main scanning direction from the relation between the time T1 and the time T2 described above. For example, when T1=T2, there is no main scanning direction color shift. When the T2 is shorter than the T1 as indicated by Ta in the drawing, it can be seen that the C-color image is shift to the left from the K-color image as indicated by a broken line 214 in the drawing. Thus, the main scanning direction color shift amount between the K-color image and the C-color image can be grasped from the time difference between T1 and Ta (see FIG. 1A).

Further, the skew amount of the K-color image can be detected from the difference (T3) between the time when the registration sensor 180a detects the main scanning direction image 200Kaa and the time when the registration sensor 180c detects the main scanning direction image 200Kca (see FIG. 1e). Further, the skew amount of the C-color image can be detected from the difference between the time when the registration sensor 180a detects the main scanning direction image 200Caa and the time when the registration sensor 180c detects the main scanning direction image 200Cca. Therefore, it is possible to calculate the skew amount between the K-color image and the C-color image by calculating the difference between the skew amount of the K-color image and the skew amount of the C-color image.

Further, the bow amount of the K-color image can be calculated from the difference (T4) between the time at which the registration sensor 180b detects the main scanning direction image 200Kba in the main scanning direction and the time at the registration sensor 180b position calculated from the skew amount (see FIG. 1f). The bow amount of the C-color image can be calculated from the difference between the time at which the registration sensor 180b detects the main scanning direction image 200Cba and the time at the registration sensor 180b position calculated from the skew amount. Therefore, it is possible to calculate the bow amount between the K-color image and the C-color image by calculating the difference between the bow amount of the K-color image and the bow amount of the C-color image.

Further, the overall magnification color shift amount of the K color can be calculated from the main scanning direction color shift between the registration pattern 200Kb and the registration pattern 200Kc as compared with the ideal image formation position in the K-color registration pattern 200K (see 1c in the figure). Similarly, the overall magnification color shift amount of the C color can be calculated from the main scanning direction color shift between the registration pattern 200Cb and the registration pattern 200Cc as compared with the ideal image formation position in the C-color registration pattern 200C. Therefore, it is possible to calculate the overall magnification color shift amount between the K-color image and the C-color image by calculating the difference between the overall magnification color shift amount of the K-color image and the overall magnification color shift amount of the C-color image.

The amount of partial magnification color shift of the K color can be calculated based on the main scanning direction color shift among the registration pattern 200Ka, the registration pattern 200Kb, and the registration pattern 200Kc as compared with the ideal image formation position in the K-color registration pattern 200K (see FIG. 1d). The partial magnification color shift amount of the C color can be calculated from the main scanning direction color shift in the registration pattern 200Ca, the registration pattern 200Cb, and the registration pattern 200Cc as compared with the ideal image formation position in the C-color registration pattern 200C. Therefore, the partial magnification color shift amount between the K-color image and the C-color image can be calculated by calculating the difference between the partial magnification color shift amount of the K-color image and the partial magnification color shift amount of the C-color image.

The controller 10 can calculate the main scanning direction color shift amounts, the sub-scanning direction color shift amounts, the overall magnification color shift amount, the partial magnification color shift amount, the skew amounts, and the bow amounts of the M color and the Y color with respect to the K color in a similar manner for the M color and the Y color other than the C color.

FIG. 7 is a diagram illustrating an example of the measurement data D1 of the color shift amount stored in the storage 20. The measurement data D1 illustrated in FIG. 7 includes, for example, the color shift amount (the numerical value in FIG. 7 is [μm]unit) calculated for each color shift type. That is, the measurement data D1 illustrated in FIG. 7 stores the main scanning direction color shift amount, the sub-scanning direction color shift amount, the overall magnification color shift amount, the partial magnification color shift amount, the skew amount, and the bow amount of each of the C color, the M color, and the Y color relative to the K color.

In the present embodiment, the controller 10 performs, for example, five measurements of the color shift amount for each of the Y, M, and the C colors with the five marks M of each of the registration patterns 200. That is, the controller 10 obtains the measurement data D1 as illustrated in FIG. 7 for five times when performing the registration correction. Note that FIG. 7 illustrates only the measurement result of one measurement, but the storage 20 stores, for example, measurement datasets D1 obtained in registration correction sequentially in time series.

After measuring the color shift amount, the controller 10 corrects the image formation condition of the toner image former 141 of each color so that the color shift of the C color, the M color, and the Y color with respect to the K color is eliminated according to the measured color shift amount.

For example, when correcting the main scanning direction color shift, the controller 10 adjusts the writing timing in the main scanning direction in the toner image former 141 of each color based on the main scanning direction color shift amount of the C color, the M color, and the Y color with respect to the K color. Thus, the writing positions of the K color, the C color, the M color and the Y color are aligned. Alternatively, the controller 10 performs correction processing on the image data of the C color, the M color, the Y color, and the K color on a pixel-by-pixel basis to align the writing positions of the K color and the C color, the M color, and the Y color.

Further, when correcting the sub-scanning direction color shift, the controller 10 adjusts the writing timing in the sub-scanning direction in the toner image former 141 for each color on the basis of the sub-scanning direction color shift amount of the C color, the M color, and the Y color with respect to the K color, and aligns the writing positions of the K color and the C color, the M color, and the Y color. Alternatively, the controller 10 performs correction processing in the sub-scanning direction on the image data of the C color, the M color, the Y color, and the K color, and aligns the writing positions of the K color and the C color, the M color, and the Y color.

Further, when correcting the skew, the controller 10 adjusts the inclination of the exposure device 1411 of the toner image former 141 of each color based on the skew amount of the C color, the M color, and the Y color with respect to the K color, thereby adjusting the inclination degree of the scanning direction of the laser light irradiated from the exposure device 1411. Alternatively, the controller 10 performs correction processing in units of pixels on the image data of the C color, the M color, the Y color, and the K color so that the skew amounts of the C color, the M color, and the Y color with respect to the K color are eliminated.

Further, when correcting the bow, the controller 10 adjusts the curved shape of the mirror (various mirrors such as a polygon mirror) included in the exposure device 1411 of the toner image former 141 of each color based on the bow amounts of the C color, the M color, and the Y color with respect to the K color. Alternatively, the controller 10 performs correction processing on the image data of the C color, the M color, the Y color, and the K color in units of pixels so that the bow amounts of the C color, the M color, and the Y color with respect to the K color are eliminated.

In addition, in a case where the overall magnification color shift amount is corrected, the controller 10 changes the number of rotations of the polygon mirror included in the exposure device 1411 of the toner image former 141 of each color based on the overall magnification color shift amount of the C color, the M color, and the Y color with respect to the K color. Alternatively, the controller 10 performs correction processing on the image data of the C color, the M color, the Y color, and the K color on a pixel-by-pixel basis so as to eliminate the overall magnification color shift amount of the C color, the M color, and the Y color with respect to the K color.

Further, in the case of correcting partial magnification color shift, the controller 10 changes the inclinations of mirrors (various mirrors such as a polygon mirror) included in the exposure devices 1411 of the toner image formers 141 of the respective colors, on the basis of the amounts of partial magnification color shift of the C color, the M color, and the Y color with respect to the K color. Alternatively, the controller 10 performs correction processing in units of pixels on the image data of the C color, the M color, the Y color, and the K color so that the partial magnification color shift amounts of the C color, the M color, and the Y color with respect to the K color are eliminated.

### Information Presenter 12

Next, a function of the information presenter 12 of the controller 10 will be described.

As described above, in the image forming apparatus 1 according to the conventional technology, when the operation of the registration corrector 11 becomes an error, the operator cannot recognize the target on which the adjustment operation is to be performed. Therefore, at the time of performing such adjustment operation, the operator is currently forced to comprehensively check each part in the image forming apparatus and adjust the components.

Therefore, in the image forming apparatus 1 according to the present embodiment, when the registration correction is performed and an error is indicated, the controller 10 presents operation assistance information to the operator, using the function of the information presenter 12.

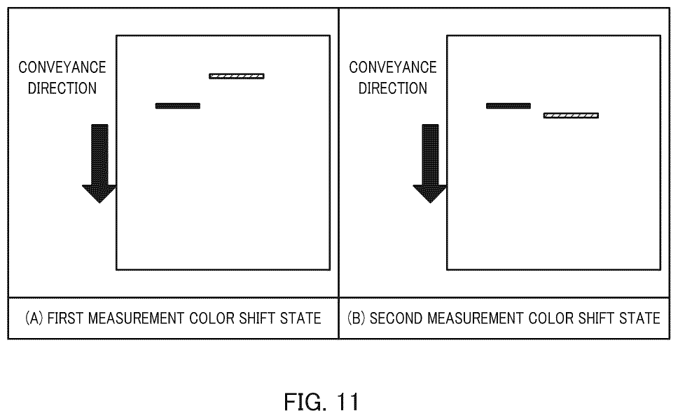

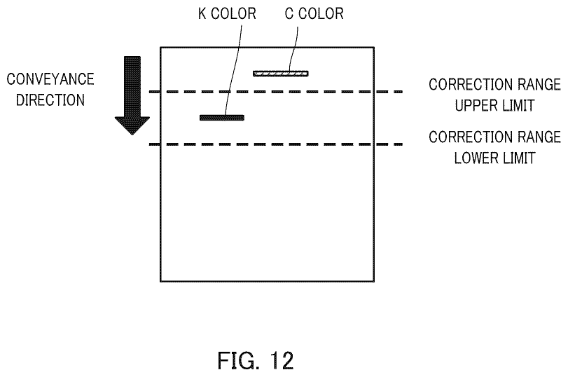

At this time, the controller 10 (information presenter 12) creates the operation assistance information with reference to the measurement data D1 of the color shift amount of each color stored in the storage 20. In the storage 20, when the registration corrector 11 enters an error state, an error flag associated with a cause of error occurrence (to be described later with reference to FIGS. 11 and 12) is attached to the measurement data D1 to be corrected. The controller 10 can specify the error-occurring color, the error-occurring color shift type, and the cause of error occurrence from the measurement data D1 to which the error flag is attached.

The controller 10 (information presenter 12) according to the present embodiment is configured to be able to present the following four types of operation assistance information.
(1) List of error statuses
(2) Suspected belt speed shift
(3) Error-related component
(4) Operation history

The controller 10 according to the present embodiment outputs and displays these types of operation assistance information on the screen of the display 120. Here, for example, a configuration is adopted in which these types of operation assistance information are displayed by appropriate selection from a main menu displayed on the screen of the display 120.

However, the controller 10 may display all of the types of operation assistance information (1) to (4) on one screen when presenting the operation assistance information. Further, when presenting the operation assistance information, the controller 10 may adopt a mode of printing out or outputting for display to an external computer.

### (1) Display of List of Error Statuses

First, a function of displaying the list of error statuses of the controller 10 will be described.

The function of displaying the list of error statuses is a function of displaying a list of normality/abnormality states of the respective colors in a manner in which an error-occurring color, an error-occurring color shift type, and a cause of error occurrence can be identified.

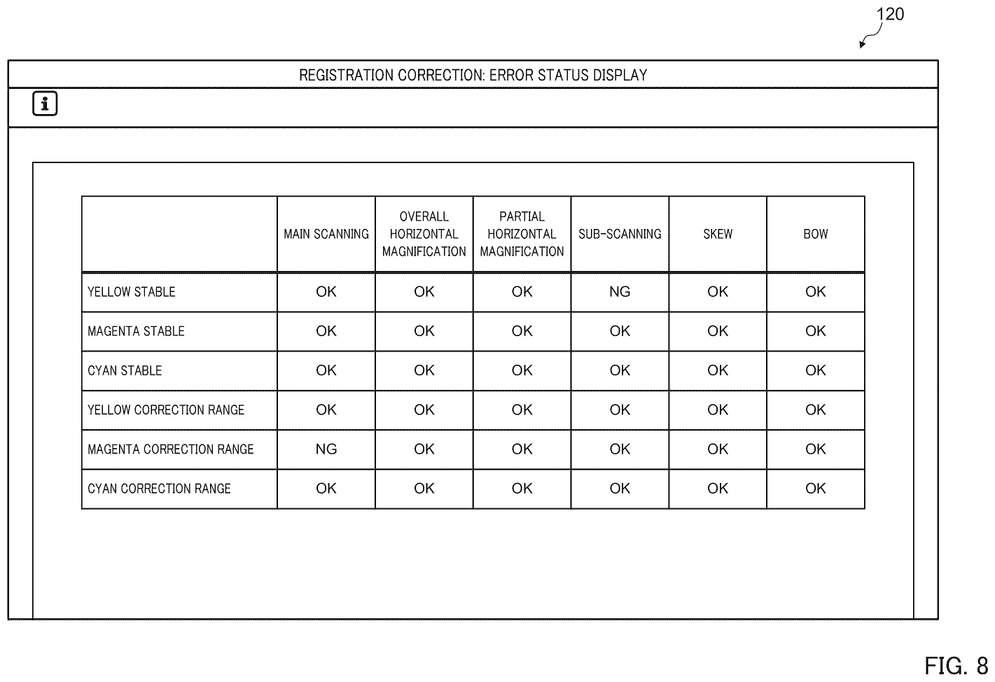

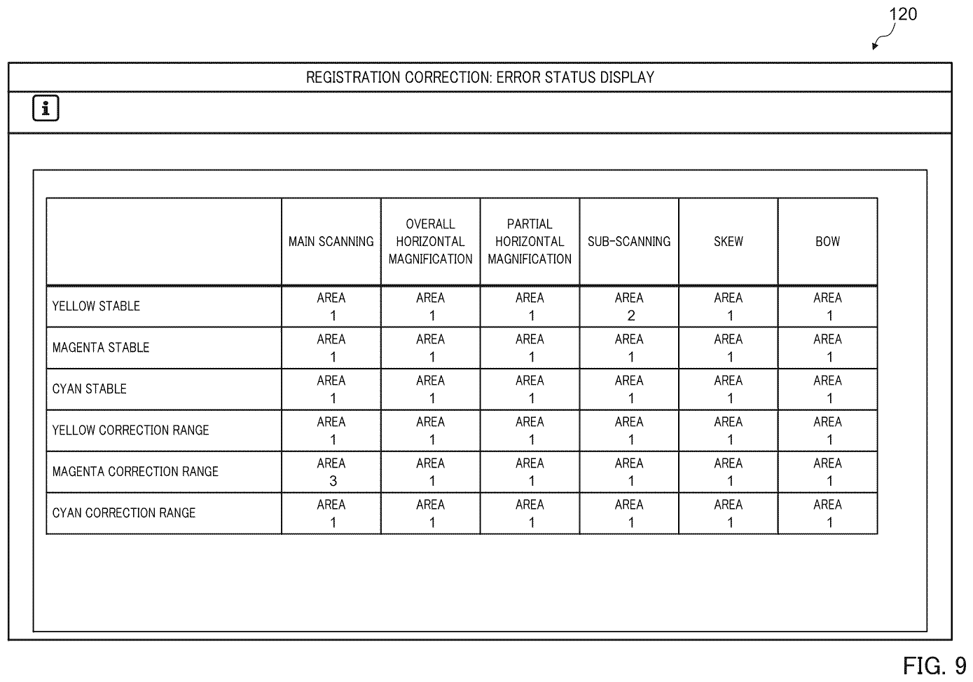

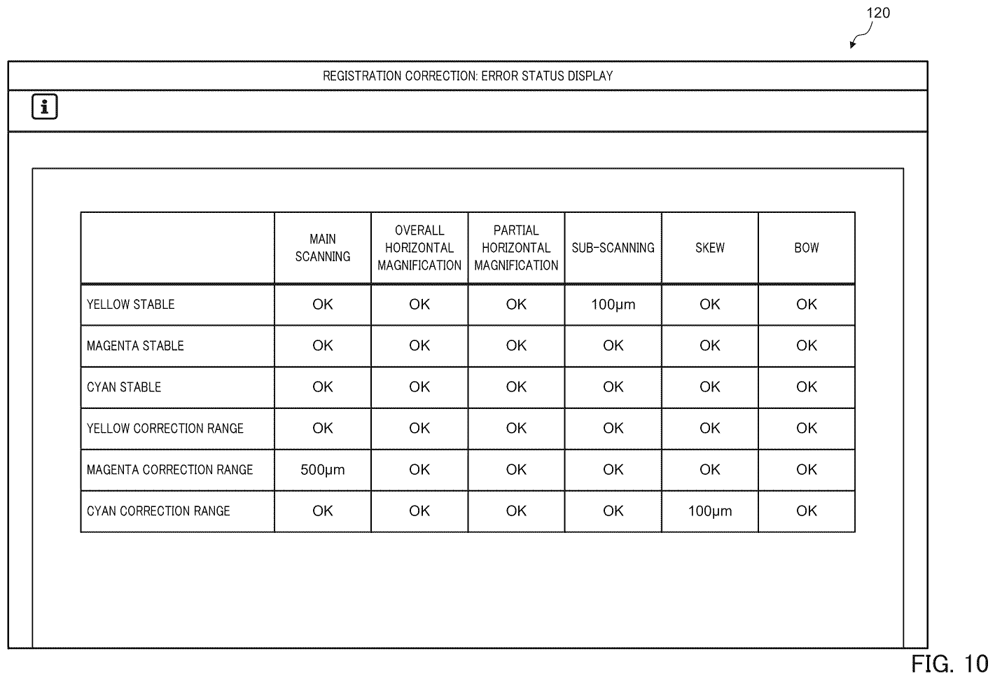

FIG. 8 is a diagram illustrating a display example 1 of a list of error statuses. FIG. 9 is a diagram illustrating a display example 2 of a list of error statuses. FIG. 10 is a diagram illustrating a display example 3 of a list of error statuses.

The following two patterns are typical causes for which the registration corrector 11 indicates an error. That is, the error cause is either “(a) the color shift amount deviates from a predetermined correctable range” or “(b) the behavior of the color shift amount differs for each measurement”.

The “Yellow correction range”, the “Magenta correction range”, and the “Cyan correction range” of the vertical axis items of FIGS. 8 to 10 are items indicating that an error has occurred due to “(a) the color shift amount deviates from a predetermined correctable range”. On the other hand, the vertical axis items “yellow stable”, “magenta stable”, and “cyan stable” in FIGS. 8 to 10 are items suggesting that an error has occurred due to “(b) the behavior of the color shift amount differs for each measurement”.

Note that in the present embodiment, the color shift amounts of the Y color, the M color, and the C color are calculated with reference to the K color, and therefore, the normality/abnormality state of each color is displayed as the abnormality of each of the Y color, the M color, and the C color.

FIG. 11 is a diagram illustrating an example of a situation in which the color shift amount is not stable. FIG. 11A is a diagram illustrating a color shift state specified in the first measurement. Further, FIG. 11B is a diagram illustrating a color shift state specified in the second measurement.

FIG. 11 illustrates a state in which the K color and the C color which should originally appear at the same position in the conveyance direction, the C color appears at a later position in the conveyance direction than the K color in the first measurement, and the C color appears at an earlier position in the conveyance direction than the K color in the second measurement.

Since color shift usually occurs due to a shift in positional accuracy of an optical system, degradation of a member over time, and the like, a change in the color shift amount in such a short time is often caused by mechanical rattling of some component or the like. Therefore, when the controller 10 (registration corrector 11) detects the registration pattern 200 of each of the Y color, the M color, and the C color, the controller 10 (registration corrector 11) outputs an error in a case where a behavior in which the color shift amount greatly differs for each measurement is illustrated.

In the present embodiment, for example, during registration correction, the controller 10 measures the color shift amount five times for each of the Y color, the M color, and the C color by using the five marks M of each of the registration patterns 200. That is, in performing the registration correction, the controller 10 obtains the measurement data D1 (see FIG. 7) for five times every time.

Then, the controller 10 determines that the color shift amount is unstable when there is at least one measurement result which is different from the other four measurement results of the color shift amount by a predetermined threshold value (for example, 63 μm) or more among the five measurement results of the color shift amount. Then, the controller 10 outputs an error, interrupts the registration correction operation, and stops the operation of the image forming apparatus 1.

FIG. 12 is a diagram illustrating an example of a situation in which the color shift amount exceeds the correctable range. In FIG. 12, the K color and the C color which should originally appear at the same position in the conveyance direction are in a state in which the C color appears at a position delayed from the K color in the conveyance direction on the measurement result, and the color shift amount exceeds the correctable range.

The controller 10 according to the present embodiment sets, as the correctable range, a correction range upper limit (for example, 1000 μm) on the conveyance direction delay position side with reference to K standard, and a correction range lower limit (for example, 1000 μm) on the conveyance direction advance position side with reference to K standard.

The controller 10 outputs an error when any of the color shift amounts of the Y color, the M color, and the C color exceeds the correctable range. Note that the controller 10 determines that the color shift amount exceeds the correctable range when the color shift amount exceeds the correctable range even once among the measurement results of the color shift amounts for five times. Then, the controller 10 outputs an error, interrupts the registration correction operation, and stops the operation of the image forming apparatus 1.

The horizontal axis items of “main scanning”, “overall horizontal magnification”, “partial horizontal magnification”, “sub-scanning”, “skew”, and “bow” in FIGS. 8 to 10 are items indicating the color shift situation of each of the six types of color shift types.

As described above, when the registration pattern 200 is detected, the controller 10 classifies the color shift type into six types of “main scanning”, “overall horizontal magnification”, “partial horizontal magnification”, “sub-scanning”, “skew”, and “bow”, and calculates the color shift amount for each of the six color shift types. Then, the controller 10 corrects the color shift amount in each of the six types of color shift types.

During the registration correction, in a case where a situation “(a) the color shift amount deviates from a predetermined correctable range” or “(b) the behavior of the color shift amount differs for each measurement” occurs in any of the six types of color shift types, the controller 10 outputs an error. In each of the six types of color shift types, the threshold value of the color shift amount for outputting an error may be set to the same value, or may be set to a different value as appropriate.

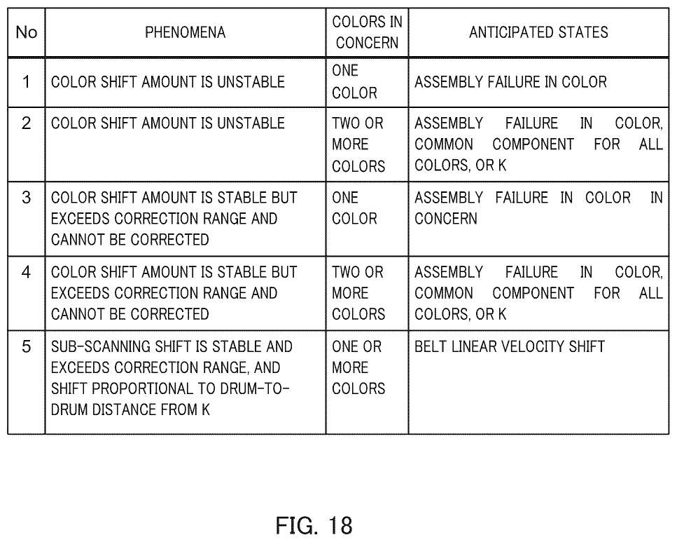

As described above, when an error occurs during the registration correction, the controller 10 recognizes that the situation is very complicated. In particular, for these elements, a plurality of errors may be output at the same time (see FIG. 18), and therefore, in order that the operator can efficiently perform the adjustment operation of the image forming apparatus 1, it is important that the operator can grasp the entire state of occurrence of the errors.

FIGS. 8, 9, and 10 are designed from this point of view.

FIG. 8 illustrates, for each of the six color shift types, a mode indicating normality/abnormality of the error causes (a) and (b) by the OK/NG information when the color shift amount is determined by the threshold value. Here, “OK” indicates that the color shift amount is equal to or smaller than the threshold value and indicates a normal state. “NG” indicates that the color shift amount exceeds the threshold value and indicates an abnormality state.

In addition, FIG. 9 illustrates a mode indicating normality/abnormality of the error causes (a) and (b) by level information when the color shift amount is classified into levels for each of the six color shift types. Here, “area 1” represents a normal state in which the color shift amount is equal to or less than the first threshold value. Further, “area 2” represents a state in which the color shift amount is equal to or larger than the first threshold value and equal to or smaller than a second threshold value (where the second threshold value > the first threshold value) and there is a possibility that an abnormality has occurred. Further, “area 3” represents a state in which the color shift amount is equal to or larger than the second threshold value and equal to or smaller than a third threshold value (where the third threshold value > the second threshold value), and an abnormality clearly occurs. In this case, a plurality of threshold values are appropriately set in accordance with the level of the abnormality.

Further, FIG. 10 illustrates a mode indicating normality/abnormality of the error causes (a) and (b) by the numerical value information of the color shift amount for each of the six color shift types. Here, the item indicating the abnormality state is represented by numerical value information of the color shift amount, and the item indicating the normal state is represented by a display of “OK”.

The controller 10 may display the normality/abnormality state of each color by combining the OK/NG information, the level information, the numerical value information, and the like as illustrated in FIGS. 8 to 10.

### (2) Display of Suspected Belt Speed Shift

Next, a function of displaying suspected belt speed shift the controller 10 will be described.

The function of displaying suspected belt speed shift by the controller 10 is a function of indicating whether there is suspected belt speed shift of the intermediate transfer belt 1421 in a case where an error occurs during registration correction.

The controller 10 determines whether the color shift amount of each color (the C color, the M color, and the Y color) in the sub-scanning direction tends to be proportional to the drum-to-drum distance between the photosensitive drum 1413 of the reference color (the K color) and the photosensitive drum 1413 of each color (the C color, the M color, and the Y color). When there is that tendency, the controller 10 displays that there is the suspected belt speed shift of the intermediate transfer belt 1421.

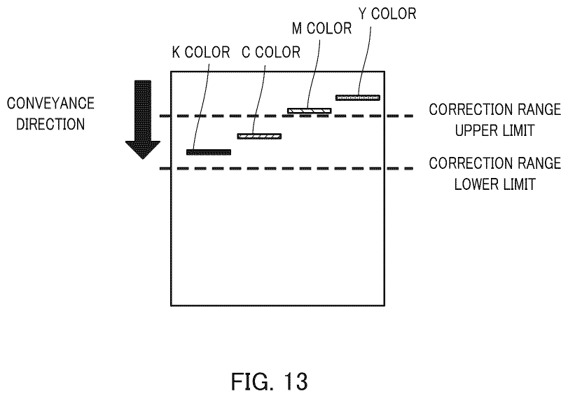

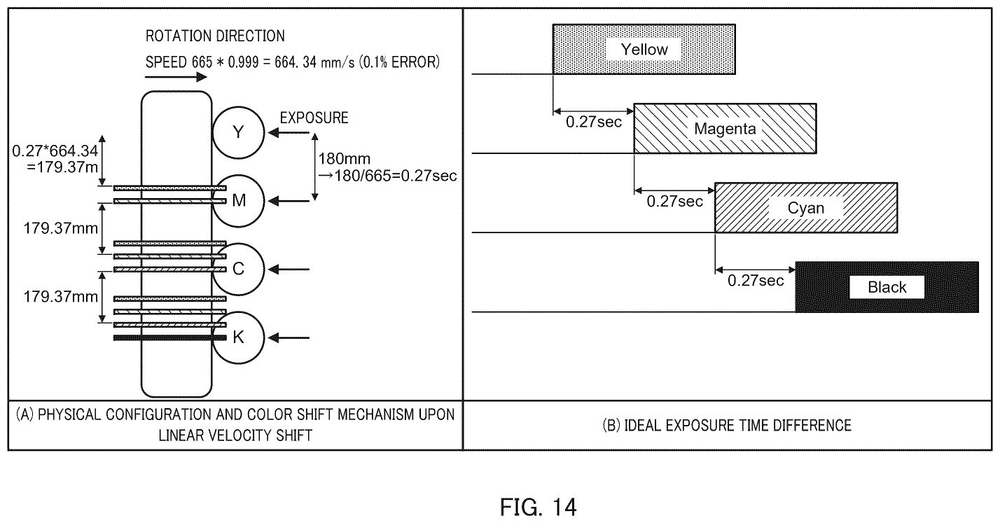

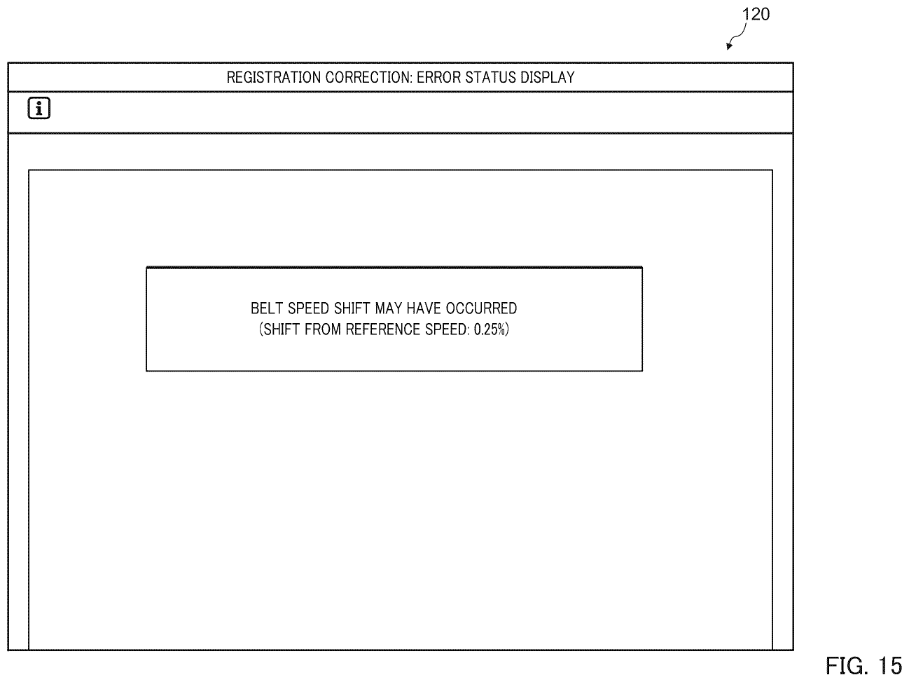

FIG. 13 is a diagram illustrating an example of a state in which the belt speed shift of the intermediate transfer belt 1421 occurs. FIG. 14 is a diagram illustrating a mechanism of occurrence of a belt speed shift of the intermediate transfer belt 1421. FIG. 15 is a diagram illustrating a display example of an alert display for a belt speed shift of the intermediate transfer belt 1421.

With respect to the cause of error occurrence indicated by the registration corrector 11, the occurrence of the situation “(a) the color shift amount deviates from a predetermined correctable range” or “(b) the behavior of the color shift amount differs for each measurement” has been described above. The belt speed shift of the intermediate transfer belt 1421 is closely related to “(a) the color shift amount deviates from a predetermined correctable range”. This is because when the belt speed shift of the intermediate transfer belt 1421 occurs, the color shift amount in the C color, the M color, or the Y color (particularly, the Y color) tends to become remarkably large.

Therefore, the controller 10 determines whether the belt speed shift occurs based on the color shift amount of each color in the sub-scanning direction.

The occurrence mechanism of the belt speed shift is as illustrated in FIG. 14. In a case where the belt speed is low, for example, when exposure is performed in the order of Y, M, C, and K with a difference of 0.27 sec that is a logical value, the Y color image does not reach the transfer position of the M color image at the time when the M color image is transferred onto the intermediate transfer belt 1421. Similarly, the C-color image is transferred onto the intermediate transfer belt 1421 before the M color image reaches the transfer position of the C-color image. As a result, color shift occurs at equal intervals in the order of K→C→M→Y on the intermediate transfer belt 1421.

Therefore, it is possible to determine whether the belt speed shift occurs depending on whether the color shift amount of each color in the sub-scanning direction tends to be proportional to the drum-to-drum distance between the photosensitive drum 1413 of the reference color (the K color) and the photosensitive drum 1413 of each color.

However, since an actual color shift amount is composed of a belt speed shift component and a component caused by a mechanical assembly error, the color shift amount of each color in the sub-scanning direction is not completely proportional to the drum-to-drum distance. However, in general, a ratio of an actual color shift amount due to the belt speed shift is considerably large, and for example, a ratio of a belt speed shift component to a component due to a mechanical assembly error is about 10:1. Therefore, it is possible to determine the presence or absence of the occurrence of the belt speed shift with sufficient accuracy by the above-described method.

Further, when displaying the indication that there is suspected belt speed shift, the controller 10 desirably estimates a belt speed shift amount of the intermediate transfer belt 1421, and displays the belt speed shift amount together (see FIG. 15). As a result, when the operator performs the adjusting operation of the intermediate transfer belt 1421, it is possible to correct the control parameter of the drive motor for driving the intermediate transfer belt 1421 and to adjust the mounting state of the intermediate transfer belt 1421.

As described above, it is possible to estimate the shift amount of the belt speed based on the color shift amount proportional to the inter-drum delay. Specifically, in the present embodiment, the color shift amounts of the Y color, the M color, and the C color are calculated with reference to the K color, and therefore, among the actual color shift amounts, the ratio due to the belt speed shift is the Y color>the M color>the C color. For example, when the color shift amounts are 1.4 mm for Y, 1.1 mm for M, and 0.5 mm for C with respect to the drum-to-drum distance of 180 mm, it can be estimated from the Y−C color shift amount that color shift of (1.4−0.5)/2=0.45 mm has occurred per drum-to-drum distance. That is, in this case, it can be estimated that a belt speed shift of 0.45/180*100=0.25% has occurred.

When estimating the belt speed shift amount, the difference in the color shift amount between the Y color and the M color and the difference in the color shift amount between the M color and the C color may be focused. That is, considering that the drum-to-drum distance is LL [mm], the color shift amounts resulting from the belt speed shift can be expressed as 3×LL [mm] for the Y color, 2×LL [mm] for the M color, and 1×LL [mm] for the C color. Therefore, the difference between the color shift amount detected for the Y color and the color shift amount detected for the M color is theoretically LL [mm]. Further, the difference between the color shift amount detected for the M color and the color shift amount detected for the C color is theoretically LL [mm]. Therefore, an average value of these differences may be estimated as the color shift amount appearing due to the belt speed shift.

### (3) Display of Error-Related Component

Next, a function of displaying the error-related component the controller 10 will be described.

The function of displaying error-related component by the controller 10 is a function of, when the registration corrector 11 indicates an error, identifying a component related to the error cause in the image forming apparatus 1 and outputting and displaying information on the component. When dealing with an error, it is useful for the operator if the operator can easily grasp a component related to the error in the image forming apparatus 1. The error-related component display function is a function for responding to such a request.

For example, first, the controller 10 specifies an error-occurring color, an error-occurring color shift type, and a cause of error occurrence, from the measurement data D1 stored in the storage 20. Next, the controller 10 identifies, from the related component data D2 stored in the storage 20, a related component corresponding to the error-occurring color, the error-occurring color shift type, and the cause of error occurrence.

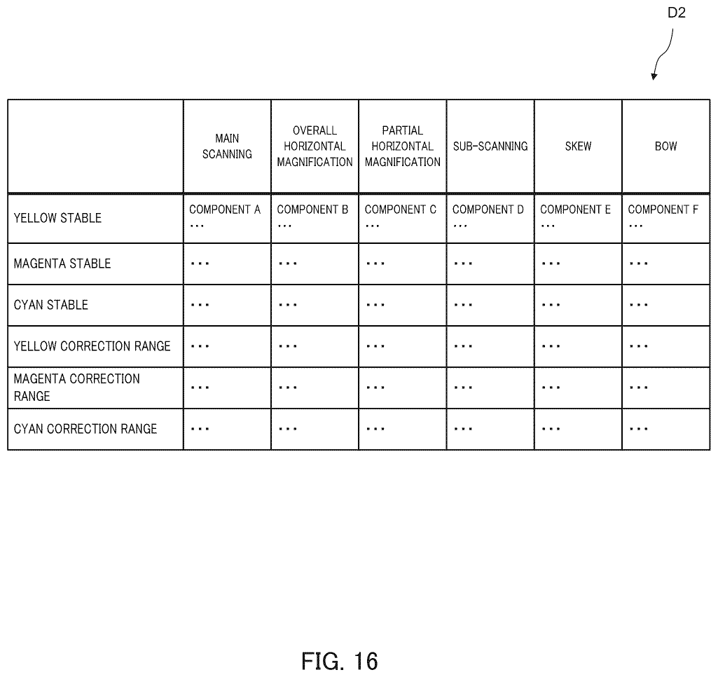

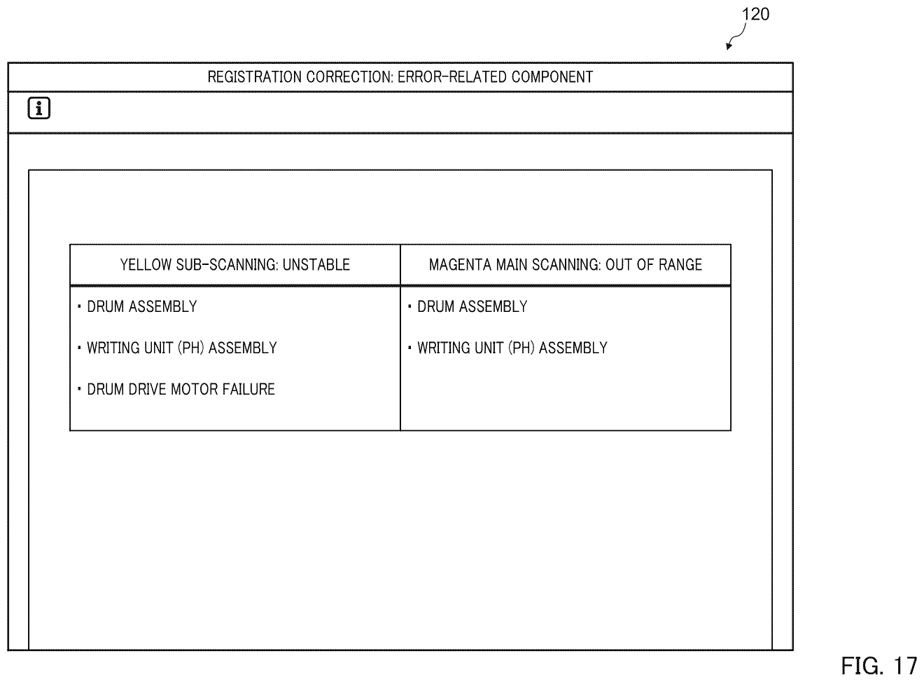

FIG. 16 is a diagram illustrating an example of related component data D2 stored in the storage 20. FIG. 17 is a diagram illustrating a display example of an error-related component display.

In the related component data D2 according to the present embodiment, for example, each component related to the registration correction is stored in advance in association with an error-occurring color, an error-occurring color shift type, and a cause of error occurrence at the time of the registration correction error. Here, as described above, there are six error-occurring color shift types: “main scanning”, “overall horizontal magnification”, “partial horizontal magnification”, “sub-scanning”, “skew”, and “bow”, for example. In addition, for example, as described above, there are two types of cause of error occurrences: “the color shift amount deviates from a predetermined correctable range” and “the color shift amount indicates a behavior that differs for each measurement”, for example.

For example, the controller 10 displays the component information related to the error in the image forming apparatus 1 as illustrated in FIG. 17. As a result, when dealing with the error, the operator can easily grasp the components related to the error in the image forming apparatus 1.

However, in actual, when the registration corrector 11 indicates an error, it is not possible to specify the cause only for the component related to the error-occurring color. This is because, for example, even when all of the components of the Y color, the M color, and the C color are normal, in a case where there is an abnormality in the K color which is the reference color, the registration corrector 11 recognizes the abnormality as an abnormality in the Y color, the M color, or the C color.

From such a viewpoint, in some cases, it is desirable that the controller 10 present all of the adjustment-required locations expected from the error status.

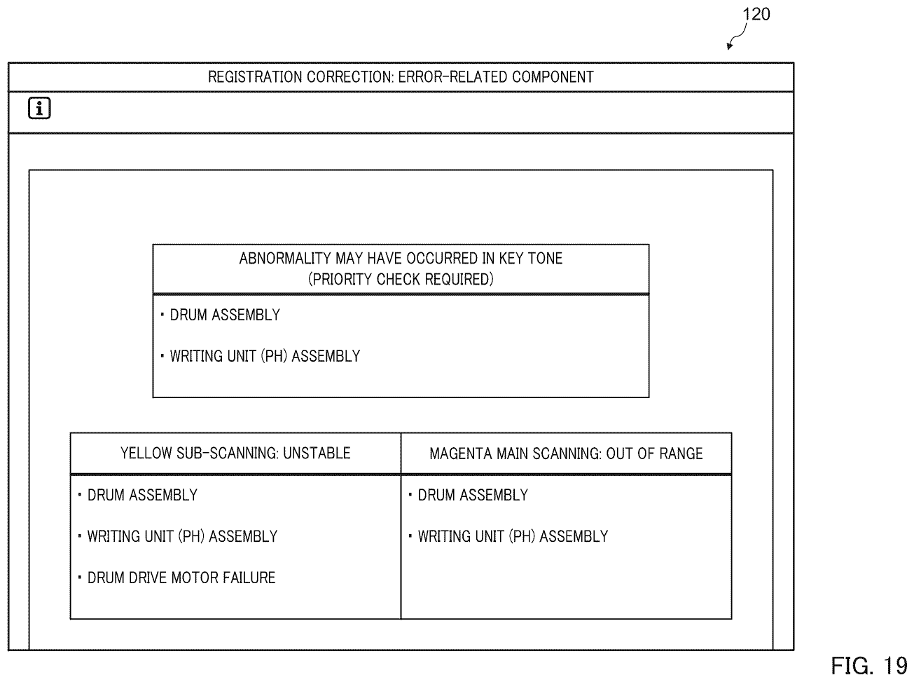

FIG. 18 is a diagram illustrating an example of an adjustment-required location expected from an error status during registration correction. FIG. 19 is a diagram illustrating a modification example of a display example of an error-related component display.

FIG. 18 illustrates an example of five patterns of adjustment-required locations expected from the error status of the registration corrector 11. Details are as follows.
(1) The error-occurring color is only one color, and the cause of error occurrence is an unstable color shift amount. => assembly failure of corresponding color needs to be considered
(2) The number of error-occurring colors is two or more, and the cause of error occurrence is an unstable color shift amount. => assembly failure of relevant color, all-color common portion, and the K color needs to be considered
(3) The error-occurring color is only one color, and the cause of error occurrence is the deviation from the color shift amount correction range. => assembly failure of corresponding color needs to be considered
(4) The number of error-occurring colors is two or more, and the cause of error occurrence is the deviation from the color shift amount correction range. => assembly failure of relevant color, all-color common portion, and the K color needs to be considered
(5) The error-occurring color is one or more colors, the cause of error occurrence is the deviation from the color shift amount correction range, and the color shift amount is proportional to the drum-to-drum distance from the K color => belt speed shift needs to be considered

In FIG. 19, the controller 10 specifies the adjustment-required locations based on the error status, and displays all of the adjustment-required locations (the relevant color, the all-color common portion, or the assembly failure of the K color) in addition to the related components specified from the related component data D2.

At this time, it is desirable that the controller 10 determines whether the related component of the color K is the cause of error occurrence so that the operator can further limit the error cause location. Thus, the controller 10 can switch, based on the determination result, whether to display the related component in the color K as an error-related component.

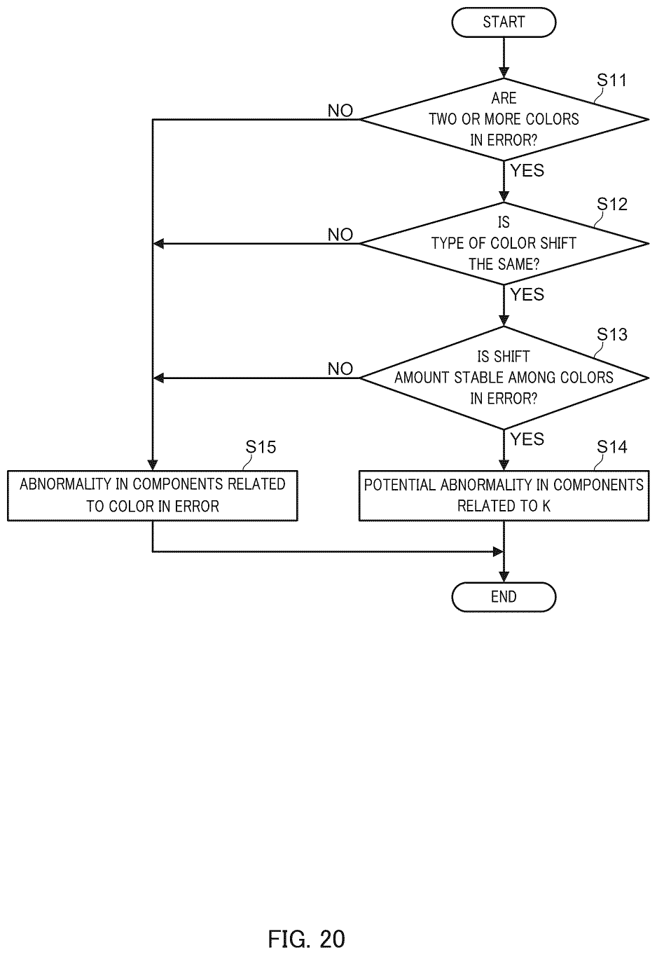

FIG. 20 is a diagram illustrating an example of a flowchart for determining whether a related component of the color K is a cause of error occurrence.

In step S11, the controller 10 determines whether the number of error-occurring colors is two or more. Here, when there are two or more error-occurring colors (step S11:YES), the controller 10 advances the process to step S12. On the other hand, when the number of error-occurring colors is less than two (step S11:NO), the controller 10 advances the process to step S15.

In step S12, the controller 10 determines whether the error color shift types of the two or more error-occurring colors are the same. Here, when the error color shift types of the two or more error-occurring colors are the same (step S12:YES), the controller 10 advances the process to step S13. On the other hand, when the error color shift types of the two or more error-occurring colors are not the same (step S12:NO), the controller 10 advances the process to step S15.

In step S13, the controller 10 calculates the difference in color shift amount between the two or more error-occurring colors, and determines whether the color shift amount between the two or more error-occurring colors is stable. Here, when the color shift amount between the two is stable (step S13:YES), the controller 10 advances the process to step S14. On the other hand, when the color shift amount between the two is not stable (step S13:NO), the controller 10 advances the process to step S15.

In step S14, the controller 10 determines that there is a risk of abnormality in the component related to the color K, and displays such information. Note that in this case, as illustrated in FIG. 19, the controller 10 displays both the component related to the K color and the component related to the error-generated color as the adjustment-required locations.

In step S15, the controller 10 specifies that the information is irrelevant to the component related to the K color, and displays the information. That is, in this case, the controller 10 treats only the component related to the error-occurring color as the component related to the error occurrence.

### (4) Display of Operation History

Next, an operation history display function of the controller 10 will be described.

The operation history display function of the controller 10 is a function of, when the registration corrector 11 indicates an error, specifying an operation history related to the error cause from among operation histories performed by the operator in the past, and displaying and outputting information of the operation history.

An error often occurs due to operation performed on the image forming apparatus 1 by the operator. Such operation includes, for example, a hardware countermeasure (for example, replacement of a component, replacement of a control board, control board connector insertion/removal) or a software countermeasure (for example, correction value change: in particular, belt speed correction or control firmware update).

From such a viewpoint, it is useful for the operator if, when the registration corrector 11 indicates an error, an operation history related to the error cause can be identified from among operation histories. The operation history display function is a function for responding to such a request.

To be specific, for example, the controller 10 first identifies the error-occurring color, the error-occurring color shift type, and the cause of error occurrence from the measurement data D1 stored in the storage 20. Then, the controller 10 specifies the operation history related to the error-occurring color, the error-occurring color shift type, and the cause of error occurrence from the operation history data D3 stored in the storage 20, and displays and outputs the operation history.

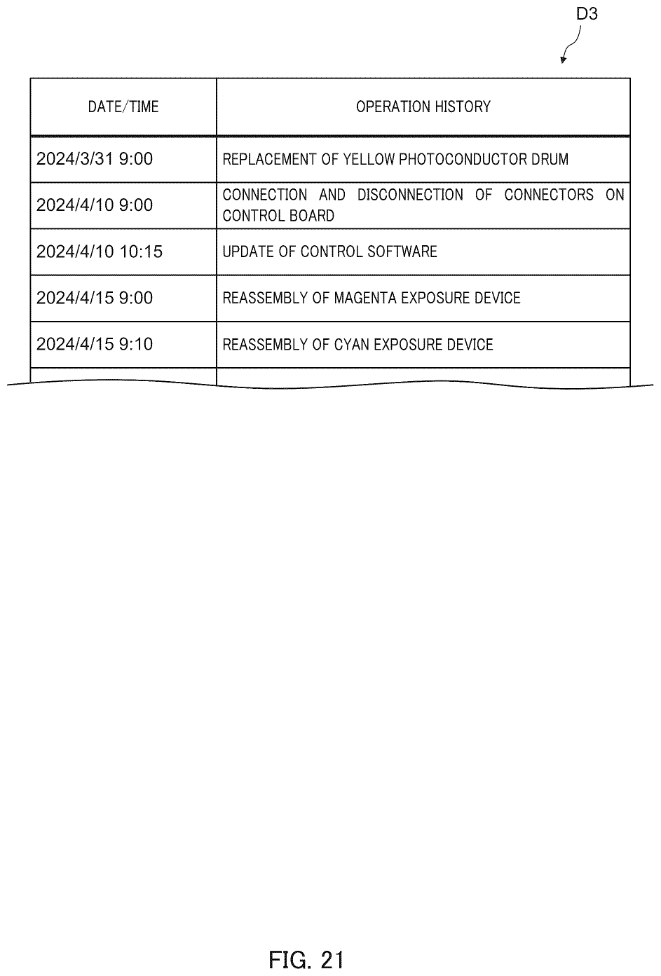

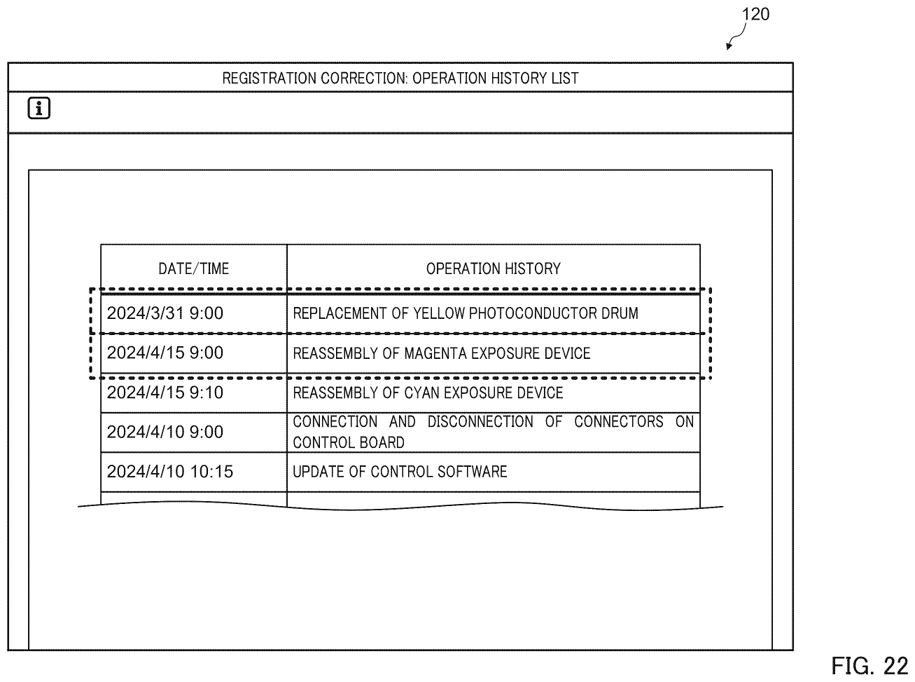

FIG. 21 is a diagram illustrating an example of the operation history data D3 stored in the storage 20. FIG. 22 is a diagram illustrating a display example of an operation history display.

The operation history data D3 stores, for example, the contents of operation performed by the operator on the image forming apparatus 1 together with the date and time of the operation. Such data is created, for example, by the operator leaving a history for each operation. Alternatively, for an operation on software (for example, correction value change: in particular, for belt speed correction or control firmware update), operation history data may be automatically created. Alternatively, it may be created by referring to data (for example, an operation report) recorded outside the apparatus.

The operation history data D3 stores, for example, a history of an operation related to at least one of disassembly of the image forming apparatus 1, replacement of a component, update of control software, a change in control parameter settings related to color shift correction, replacement of a control board, insertion/removal of a control board connector, and replacement of a harness for the image forming apparatus 1.

Since such operation is basically determined in advance, it is possible to associate it with the influence on the registration correction in advance, for example.

Therefore, the controller 10 can refer to the error-occurring color, the error-occurring color shift type, and the cause of error occurrence of the measurement data D1 to which the error flag is currently attached, and can specify the operation history corresponding to these from the operation history data D3.

FIG. 22 illustrates, as an example, a mode in which an operation history highly relevant to an error is specified from the operation history data D3 and is preferentially displayed in the operation list. The controller 10, for example, highlights the operation history having a high relevance to the error or displays the operation history at the top of the operation list.

Note that at this time, it is desirable to list the operation histories stored in the operation history data D3 in ascending order of time and date from the time and date of error occurrence. Basically, this is because it is highly likely that the most recent operation has caused an error in the registration correction.

Provided that the controller 10 may delete the operation history data D3 when the registration correction is completed normally.

Since an error due to an assembly error occurs many times in one apparatus, an error solved in the past is not related to an error-occurring at present. Therefore, it is not desirable to display the solved estimated factors when the past history is also referred to.

Therefore, desirably, after interruption of the correction processing due to an error, the controller 10 performs the correction processing again based on a user instruction, and when the error has been eliminated, the controller 10 performs processing of deleting the operation history data D3 stored in the storage 20, for example.

### Effects

As described above, the image forming apparatus according to the present embodiment includes:
a registration corrector that detects a formation manner of a registration pattern of each color formed on the intermediate transfer belt by a registration sensor, and corrects a color shift amount of each color based on a detection result;
a first storage that stores measurement data of the color shift amount of each color measured by the registration corrector; and
an information presenter that presents operation assistance information to an operator based on the measurement data stored in the first storage when the registration corrector indicates an error.

Thus, when the operator performs adjustment operation for the image forming apparatus to deal with a registration correction error, the operator can perform the operation while limiting error cause location in the apparatus. That is, thus, the operator can efficiently perform the adjustment operation of the image forming apparatus. Thus, it is possible to suppress a situation in which the operator overlooks a component that should be adjusted in the image forming apparatus when an error occurs.

Although embodiments of the present invention have been described and illustrated in detail, it is clearly understood that the same is by way of illustration and example only and not limitation, the scope of the present invention should be interpreted by terms of the appended claims.

What is claimed is:

1. An image forming apparatus that forms a color image by superimposing on an intermediate transfer belt images formed on a photosensitive drum of each color, the image forming apparatus comprising:
the photosensitive drum of each color;
a hardware processor that functions as a registration corrector and an information presenter; and
a first storage,
wherein with a registration sensor, the registration corrector detects a formation manner of a registration pattern of each color formed on the intermediate transfer belt, and corrects a color shift amount of each color based on a detection result,
wherein the first storage stores measurement data of the color shift amount of each color measured by the registration corrector, and
wherein the information presenter presents operation assistance information to an operator based on the measurement data stored in the first storage when the registration corrector indicates an error.

2. The image forming apparatus according to claim 1, wherein the information presenter displays, as the operation assistance information, a list of normality/abnormality states of each color in a manner in which an error-occurring color, an error-occurring color shift type, and a cause of error occurrence are identifiable.

3. The image forming apparatus according to claim 2, wherein the error-occurring color shift type includes at least one of a color shift in a main scanning direction, a color shift in a sub-scanning direction, a color shift due to a total magnification error, a color shift due to a partial magnification error, a color shift due to an image inclination, and a color shift due to an image curvature.

4. The image forming apparatus according to claim 2, wherein the cause of error occurrence includes any one of a state in which the color shift amount deviates from a predetermined correctable range and a state in which a behavior of the color shift amount differs for each measurement.

5. The image forming apparatus according to claim 2, wherein the information presenter displays a normality/abnormality state of each color by OK/NG information obtained by determining the color shift amount by a threshold value, level information obtained by classifying the color shift amount into levels, and/or numerical value information of the color shift amount.

6. The image forming apparatus according to claim 1, wherein the information presenter determines whether the color shift amount in the sub-scanning direction of each color specified from the measurement data tends to be proportional to a drum-to-drum distance between the photosensitive drum of a reference color and the photosensitive drum of each color, and when the color shift amount tends to be proportional to the drum-to-drum distance, the information presenter displays an indication that there is suspected belt speed shift of the intermediate transfer belt as the operation assistance information.

7. The image forming apparatus according to claim 6, wherein when there is the suspected belt speed shift, the information presenter estimates a belt speed shift amount of the intermediate transfer belt based on the color shift amount of each color in a sub-scanning direction, and displays the belt speed shift amount as the operation assistance information.

8. The image forming apparatus according to claim 1, further comprising a second storage that stores information of each component in the image forming apparatus,
wherein the information presenter specifies a component related to the error in the image forming apparatus from the second storage based on an error-occurring color, an error-occurring color shift type, and a cause of error occurrence specified from the measurement data, and displays information on the component as the operation assistance information.

9. The image forming apparatus according to claim 8, wherein when there are two or more of the error-occurring colors and the two or more error-occurring colors indicate the same error-occurring color shift type, the information presenter displays, as the operation assistance information, information indicating that there is a possibility that an abnormality has occurred in a component related to a reference color serving as a reference for calculating the color shift amount of each color.

10. The image forming apparatus according to claim 8, wherein when there are two or more of the error-occurring colors and the two or more error-occurring colors indicate the same error-occurring color shift type, and, the color shift amount between the two or more error-occurring colors are stable, the information presenter displays, as the operation assistance information, information indicating that there is a possibility that an abnormality has occurred in a component related to a reference color serving as a reference for calculating the color shift amount of each color.

11. The image forming apparatus according to claim 1, further comprising a third storage that stores an operation history of an operation performed on the image forming apparatus,
wherein the information presenter extracts the operation history for a component related to the error from the operation history stored in the third storage based on an error-occurring color, an error-occurring color shift type, and a cause of error occurrence specified from the measurement data, and displays the operation history as the operation assistance information.

12. The image forming apparatus according to claim 11, wherein the operation history includes an operation related to at least one of disassembly of the image forming apparatus, replacement of a component, update of control software, a change in control parameter settings related to color shift correction, replacement of a control board, insertion/removal of a control board connector, and replacement of a harness.

13. The image forming apparatus according to claim 11, wherein after interruption of correction processing due to the error, the registration corrector performs the correction processing again based on a user instruction, and when the error has been eliminated, the registration corrector deletes the operation history stored in the third storage.
